(19) United States
(12) Patent Application Publication
(10) Pub. No.: US 2025/0061642 A1
(43) Pub. Date: Feb. 20, 2025

(54) PARTICLE SPECIAL EFFECT RENDERING METHOD AND APPARATUS, AND DEVICE AND STORAGE MEDIUM

(71) Applicant: Lemon Inc., Grand Cayman (KY)

(72) Inventors: Anda LI, Los Angeles, CA (US); Jiali PAN, Beijing (CN)

(21) Appl. No.: 18/723,358

(22) PCT Filed: Dec. 22, 2022
(86) PCT No.: PCT/SG2022/050924

§ 371 Date: Jun. 21, 2024

(30) Foreign Application Priority Data
Dec. 22, 2021 (CN) 202111582801.X

(51) Int. Cl. G06T 15/04; G06T 17/20

(52) U.S. Cl. CPC G06T 15/04; G06T 17/20; G06T 2210/56

(57) ABSTRACT

The present disclosure provides a particle effect rendering method, a device, and a storage medium. The method includes: obtaining an object to be rendered; generating a force field corresponding to the object to be rendered based on the object to be rendered; based on a 3D texture map of the force field, obtaining, according to a vector value corresponding to a first position of a particle in the force field in an image frame at a t-th moment, a second position of the particle in the force field in an image frame at a (t+1)-th moment; and rendering and generating, according to the second position of the particle, the image frame at the (t+1)-th moment, so as to obtain a particle effect rendering result of the object to be rendered according to respective image frames.

### CROSS-REFERENCE TO RELATED APPLICATION

The present disclosure claims priority of the Chinese Patent Application No. 202111582801.X, filed on Dec. 22, 2021, entitled “Particle Effect Rendering Method, apparatus, device, and storage medium”, the entire disclosure of which is incorporated herein by reference.

### TECHNICAL FIELD

Embodiments of the present disclosure relate to the field of computer technology, and in particular, to a particle effect rendering method and apparatus, a device, a storage medium, a program product, and a computer program.

### BACKGROUND

The particle system, which is one of commonly used technologies for simulating specific phenomena or visual effects in computer graphics, has a unique advantage in simulating natural phenomena, physical effects, etc., can implement some effects that are real and natural and have random properties, and has a wide range of applications in the fields of image processing, video editing, game effects, etc.

In the related art, when particle rendering is performed on a three-dimensional (3D) object, three-dimensional information of the object needs to be obtained, so that particles can generate a rendering effect according to the three-dimensional information of the object. However, this three-dimensional information is often obtained in the form of triangular vertex information of the object, when the particles generate a rendering effect according to the triangular vertex information, the particles needs to do collision detection with all triangles, and this process is relatively complex, making the efficiency of the particle specific effect rendering low and making the rendering effect poor.

### SUMMARY

Embodiments of the present disclosure provide a particle effect rendering method and apparatus, a device, a storage medium, a program product, and a computer program for reducing the complexity of the particle effect rendering and improving the efficiency of the particle effect rendering.

In a first aspect, embodiments of the present disclosure provide a particle effect rendering method, comprising:
obtaining an object to be rendered; generating, based on the object to be rendered, a force field corresponding to the object to be rendered, the force field comprising one or more positions, and a vector value corresponding to the position being used to indicate a force applied to a particle when the particle is at the position; based on a 3D texture map of the force field, obtaining, according to a vector value corresponding to a first position of a particle in the force field in an image frame at a t-th moment, a second position of the particle in the force field in an image frame at a (t+1)-th moment, t being a non-negative integer; and rendering and generating, according to the second position of the particle in the image frame at the (t+1)-th moment, the image frame at the (t+1)-th moment, so as to obtain a particle effect rendering result of the object to be rendered according to image frames corresponding to respective moments in a preset time period.

According to one or more embodiments of the present disclosure, the obtaining, according to a vector value corresponding to a first position of a particle in the force field in an image frame at a t-th moment, a second position of the particle in the force field in an image frame at a (t+1)-th moment comprises:
obtaining a force applied to the particle when the particle is at the first position according to the vector value corresponding to the particle at the first position; and
obtaining the second position of the particle in the force field in the image frame at the (t+1)-th moment according to the force applied to the particle when the particle is at the first position.

According to one or more embodiments of the present disclosure, the obtaining the second position of the particle in the force field in the image frame at the (t+1)-th moment according to the force applied to the particle when the particle is at the first position comprises:
obtaining a mass of the particle and an initial velocity of the particle at the first position; obtaining an acceleration of the particle at the first position according to the force applied to the particle when the particle is at the first position and the mass of the particle; and obtaining the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

According to one or more embodiments of the present disclosure, the force field comprises a vector field.

According to one or more embodiments of the present disclosure, the force field comprises a signed distance field, and the signed distance field further comprises a shortest distance between each of the positions and a surface of the object to be rendered.

The particle effect rendering method further comprises: determining a shortest distance between the first position and the surface of the object to be rendered; and determining a force applied to the particle when the particle is at the first position according to the shortest distance and the vector value corresponding to the first position.

According to one or more embodiments of the present disclosure, the generating, based on the object to be rendered, a force field corresponding to the object to be rendered comprises: obtaining a three-dimensional mesh model corresponding to the object to be rendered; and generating the force field corresponding to the object to be rendered based on the three-dimensional mesh model.

In a second aspect, embodiments of the present disclosure provide a particle effect rendering apparatus, comprising:
a first obtaining module, configured to obtain an object to be rendered;
a generation module, configured to generate, based on the object to be rendered, a force field corresponding to the object to be rendered, the force field comprising one or more positions, and a vector value corresponding to the position being used to indicate a force applied to a particle when the particle is at the position;
a second obtaining module, configured to, based on a 3D texture map of the force field, obtain, according to a vector value corresponding to a first position of a particle in the force field in an image frame at a t-th moment, a second position of the particle in the force field in an image frame at a (t+1)-th moment, t being a non-negative integer; and a rendering module, configured to render and generate, according to the second position of the particle in the image frame at the (t+1)-th moment, the image frame at the (t+1)-th moment, so as to obtain a particle effect rendering result of the object to be rendered according to image frames corresponding to respective moments in a preset time period.

In a third aspect, an embodiment of the present disclosure provides an electronic device, comprising: at least one processor and a memory; the memory stores computer-executable instructions; when the at least one processor executes the computer-executable instructions stored in the memory, the at least one processor is caused to perform any one particle effect rendering method as described in the first aspect.

In a fourth aspect, an embodiment of the present disclosure provides a computer-readable storage medium, the computer-readable storage medium stores computer-executable instructions, when a processor executes the computer-executable instructions, any one particle effect rendering method as described in the first aspect is implemented.

In a fifth aspect, embodiments of the present disclosure provide a program product comprising: a computer program, and the computer program, when executed by a processor, implements any one particle effect rendering method as described in the first aspect.

In a sixth aspect, embodiments of the present disclosure provide a computer program, the computer program, when executed by a processor, implements any one particle effect rendering method as described in the first aspect.

Embodiments of the present disclosure provide a particle effect rendering method and apparatus, a device, a storage medium, a program product, and a computer program. The method includes: obtaining an object to be rendered; generating, based on the object to be rendered, a force field corresponding to the object to be rendered; based on a 3D texture map of the force field, obtaining, according to a vector value corresponding to a first position of a particle in the force field in an image frame at a t-th moment, a second position of the particle in the force field in an image frame at a (t+1)-th moment; rendering and generating, according to the second position of the particle in the image frame at the (t+1)-th moment, the image frame at the (t+1)-th moment, so as to obtain a particle effect rendering result of the object to be rendered according to respective image frames. In the embodiments of the present disclosure, dynamic rendering of particles can be achieved by force field implementation, a spectacular rendering effect can be achieved, and the force field of the object to be rendered is represented by a 3D texture map, so that the position of the particle in the force field with respect to the object to be rendered can be quickly obtained, thereby greatly improving the particle rendering efficiency.

### BRIEF DESCRIPTION OF DRAWINGS

In order to more clearly illustrate the technical solutions of the embodiments of the present disclosure or the prior art, the drawings required for describing the embodiments or the prior art will be briefly described in the following; it is obvious that, the drawings in the following description are some embodiments of the present disclosure, those skilled in the art can obtain other drawing(s) according to these drawings, without any inventive work.

FIG. 1 is a schematic diagram of a scenario of a particle effect rendering method according to an embodiment of the present disclosure;

FIG. 2 is a first schematic flowchart diagram of a particle effect rendering method according to an embodiment of the present disclosure;

FIG. 3 is a schematic diagram of a force field according to an embodiment of the present disclosure;

FIG. 4 is a first schematic diagram of a principle of a particle effect rendering method according to an embodiment of the present disclosure;

FIG. 5 is a second schematic flowchart diagram of a particle effect rendering method according to an embodiment of the present disclosure;

FIGS. 6(a) to 6(d) are second schematic diagrams of a principle of a particle effect rendering method according to an embodiment of the present disclosure;

FIG. 7 is a structural schematic diagram of a particle effect rendering apparatus according to an embodiment of the present disclosure; and

FIG. 8 is a structural schematic diagram of an electronic device according to an embodiment of the present disclosure.

### DETAILED DESCRIPTION

In order to make the objects, technical solutions, and advantages of the embodiments of the present disclosure clearer, the technical solutions in the embodiments of the present disclosure will be clearly and completely described below in conjunction with the accompanying drawings in the embodiments of the present disclosure, it is obvious that the described embodiments are just a part but not all of the embodiments of the present disclosure. Based on the embodiments in the present disclosure, all other embodiments obtained by those of ordinary skill in the art without any inventive work belong to the scope of protection of the present disclosure.

In the related art, when particle rendering is performed on a three-dimensional object, three-dimensional information of the object needs to be obtained, so that particles generate a rendering effect according to the three-dimensional information of the object. However, this three-dimensional information is often obtained in the form of triangular vertex information of the object, when the particles generate a rendering effect according to the triangular vertex information, the particles needs to do collision detection with all triangles, and this process is relatively complex, making the efficiency of the particle specific effect rendering low and making the rendering effect poor. In addition, in the rendering process, the particle is usually generated directly at the position of the object based on the position information of the object, and the rendering effect is poor.

In view of this, the embodiments of the present disclosure provide a particle effect rendering method and apparatus, a device, and a storage medium, the rendering of the particle effect is achieved by force field implementation, so that dynamic rendering of particles is achieved, thus obtaining a more spectacular rendering effect; and the force field of the object to be rendered is represented by a 3D texture map, so that the position of the particle in the force field with respect to the object to be rendered can be quickly obtained, thereby greatly improving the particle rendering efficiency.

It should be noted that the particle effect rendering method in the embodiments of the present disclosure can be implemented by a terminal device and can also be implemented by a specific functional architecture in the terminal device, the implementation of the present disclosure is introduced below with a terminal device as an execution body in the embodiments of the present disclosure, and in other alternative embodiments, other computer systems or functional structural modules of a computer system can also be used to implement corresponding steps in the embodiments of the present disclosure, and the embodiments of the present disclosure are not limited thereto.

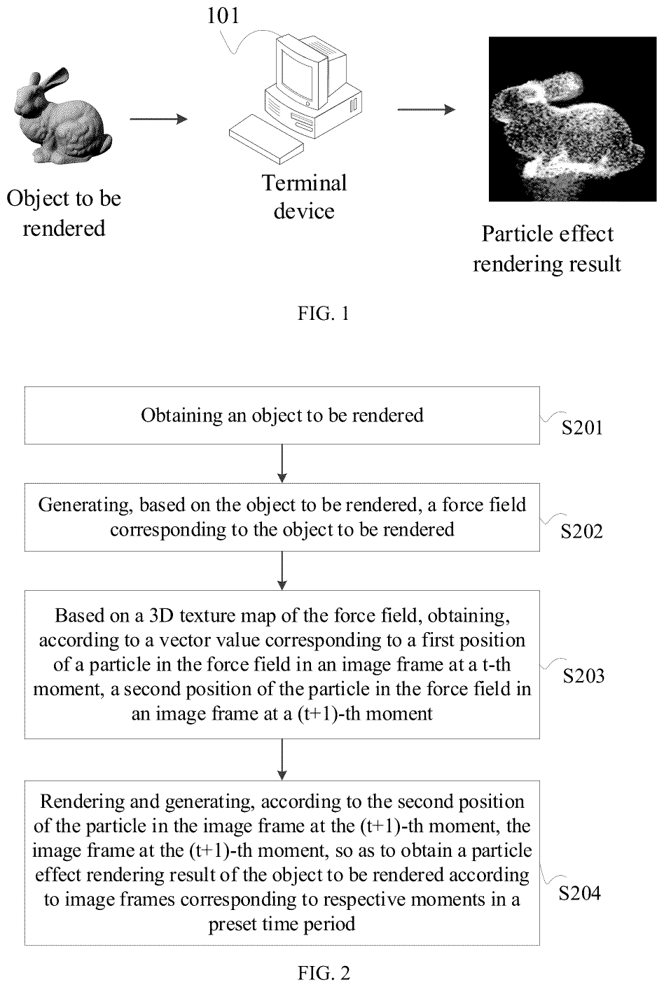

FIG. 1 is a schematic diagram of a scenario of a particle effect rendering method according to an embodiment of the present disclosure. As shown in FIG. 1, a terminal device 101 is included in this scenario.

Therein, the terminal device 101 can be a personal digital assistant (PDA) device, a computing device (e.g., a personal computer (PC)), or the like. It should be understood that a desktop computer is shown in FIG. 1 as an example, but the present disclosure is not limited thereto.

In the solution of the embodiment of the present disclosure, an arbitrary three-dimensional object can be input into the terminal device 101, and the particle specific effect rendering result shown in FIG. 1 is obtained by the terminal device 101. It should be noted that the particle specific effect rendering result is a process in which particles dynamically constitutes the shape of the object to be rendered.

The technical solutions of the embodiments of the present disclosure and how the technical solutions of the present disclosure solve the above technical problems are explained in detail below through specific embodiments. The following several specific embodiments can be combined with each other, and the same or similar concepts or processes may not be repeated in some embodiments. Embodiments of the present disclosure will be described below with reference to the accompanying drawings.

FIG. 2 is a first schematic flowchart diagram of a particle effect rendering method according to an embodiment of the present disclosure. As shown in FIG. 2, the particle effect rendering method provided by an embodiment of the present disclosure includes the following steps:
S201, obtaining an object to be rendered.

It should be noted that the object to be rendered may be any type of 3D object, and embodiments of the present disclosure do not particularly limit the type of the object to be rendered.
S202, generating, based on the object to be rendered, a force field corresponding to the object to be rendered.

The force field is a unified grid composed of vectors affecting the movement of the particle, the movement of the particle will be affected by the force field when the particle enters a boundary of the force field, and the affecting of the force field on the particle disappears immediately when the particle leaves the boundary, the force field includes one or more positions, and a vector value corresponding to each position is used to indicate a force applied to a particle when the particle is at that position.

It should be noted that the embodiments of the present disclosure do not specifically limit the division manner of the positions in the force field, in a preferred implementation, a volume pixel (voxel) corresponding to the force field can be obtained, and one position in the force field corresponds to at least one volume pixel, i.e., one position in the force field is represented by at least one volume pixel.

Taking one position represented by one volume pixel as an example, each volume pixel in the force field corresponds to a vector value, which is used to indicate the force exerted on the particle at the volume pixel, and when the particle runs to the volume pixel, the particle moves under the affecting of the force corresponding to the volume pixel, thereby causing the particle to produce a dynamic effect.

In some embodiments, the magnitude of the vector value corresponding to each position in the force field is related to the distance between the position and the surface of the object to be rendered, and in particular, the farther the distance between the position (including positions inside the object to be rendered and outside the object to be rendered) and the surface of the object to be rendered, the larger the vector value corresponding to the position, and the larger the force to be exerted.

In addition, a direction of the vector value corresponding to each position in the force field is a vertical direction toward the nearest surface of the object to be rendered.

It should be noted that the vector value corresponding to the position where the surface of the object to be rendered is located is preferably 0.

It should be understood that by setting the vector value corresponding to the position at which the surface of the object to be rendered to be 0, the force applied to the particle when the particle is at the surface of the object to be rendered is 0, when the particle reaches the surface of the object to be rendered, the particle no longer moves, and the shape of the object to be rendered can be rendered through particles located at the surface of the object to be rendered.

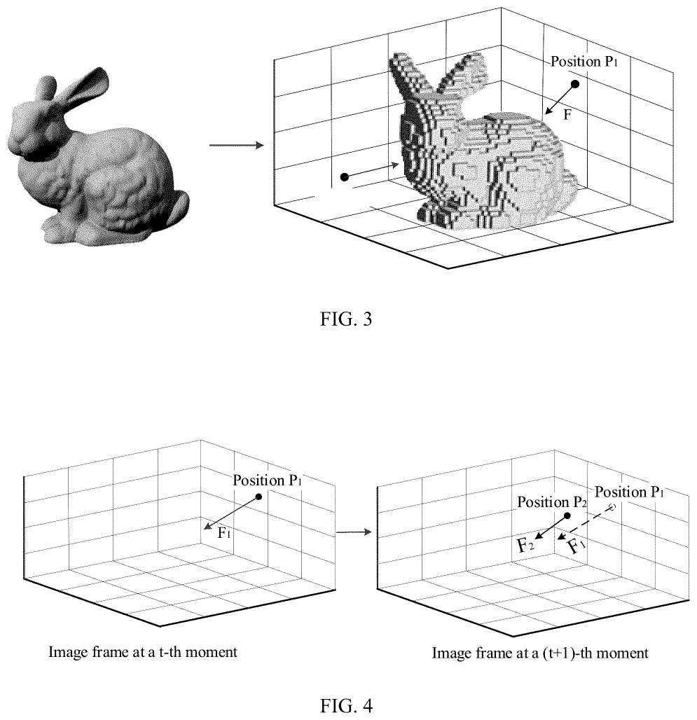

FIG. 3 is a schematic diagram of a force field according to an embodiment of the present disclosure. As shown in FIG. 3, the force field is shown in the form of a 3D texture map, illustratively, in the 3D texture map, for a position P₁, which is not a position of the surface of the object to be rendered, the position P₁ corresponds to a force of F₁; for a position P₂, which is a position of the surface of the object to be rendered, a vector value corresponding to the position P₂ is 0 and a force corresponding to the position P₂ is also 0.
S203, based on a 3D texture map of the force field, obtaining, according to a vector value corresponding to a first position of a particle in the force field in an image frame at a t-th moment, a second position of the particle in the force field in an image frame at a (t+1)-th moment.
S204, rendering and generating, according to the second position of the particle in the image frame at the (t+1)-th moment, the image frame at the (t+1)-th moment, so as to obtain a particle effect rendering result of the object to be rendered according to image frames corresponding to respective moments in a preset time period.

In an embodiment of the present disclosure, after obtaining the force field of the object to be rendered, the force field is imported into a GPU of a computer system in the form of a 3D texture map, and a Shader in the GPU obtains position information of respective particles in the force field in real time according to the 3D texture map, and draws particles in real time at corresponding positions according to the position information to obtain an image composed of the particles.

In particular, before drawing the particles, the relevant properties of the particle first need to be set, and a particle system is generated for rendering the object to be rendered. Among them, the relevant properties of the particle are, for example, the particle lifecycle range, the particle initial velocity range, the particle mass range, and the like.

Further, the lifecycle of each particle is randomly determined within the particle lifecycle range, the initial velocity of each particle is randomly determined within the particle initial velocity range, and the mass of each particle is randomly determined within the particle mass range, so that each particle in the particle system for rendering the object to be rendered is generated according to the lifecycle, the initial velocity, and the mass of each particle. It should be understood that the lifecycles, velocities, and masses of respective particles in the particle system are randomly distributed within the corresponding ranges, respectively.

According to one or more embodiments of the present disclosure, the relevant properties of the particle further include: initial position of the particle, particle color, and the like, which are not shown here one by one.

Further, a particle emitter in the GPU emits particles in the particle system into the force field according to the relevant properties of the particles. After the respective particles enter the force field, positions of the respective particles are different, the respective particles moves under the affecting of the forces corresponding to the different positions, thereby reaching the different positions at the different moments, so that the position information of the particle at the next moment is calculated by the vector value of the position at which the particle is located at the current moment, and then the particles corresponding to the moment are drawn in the force field based on the position information and the relevant properties of the particles, thereby obtaining the image frame corresponding to the moment, and the picture composed of the image frames corresponding to respective moments in the preset time period is the particle specific effect rendering result corresponding to the object to be rendered.

It should be noted that the embodiments of the present disclosure do not limit the preset time period. In one aspect, the preset time period may be a preset rendering time period set by the user before the rendering. For example, the preset rendering time period may be set by the user according to the requirements before the particles enter the force field, in the rendering process, the time is counted from the initial moment when the particle enters the force field, when the rendering time period reaches the preset rendering time period, i.e., the rendering is completed, the picture composed of the image frames corresponding to the respective moments in the rendering time period is determined to be the particle effect rendering result.

On the other hand, the preset time period can also be a rendering time period randomly adjusted by the user during the rendering process. For example, in the rendering process, the user can control an end moment of the rendering process according to real-time rendering situation, a time period from an initial moment when the particle enters the force field to the end moment is determined as the preset time period, and the picture composed of the image frames corresponding to the respective moments in the preset time period is determined as the particle effect rendering result corresponding to the object to be rendered.

FIG. 4 is a first schematic diagram of a principle of a particle effect rendering method according to an embodiment of the present disclosure. As shown in FIG. 4, taking one particle as an example, in the image frame corresponding to the t-th moment, the particle is at a position P₁, the magnitude of the force applied to the particle when the particle is at the position P₁ is F₁, and a direction of F₁ is the vertical direction towards the surface of the object to be rendered.

At the t-th moment, the particle is affected by F₁ to move towards the surface of the object to be rendered, and at the (t+1)-moment, the particle moves to a position P₂, the particle is drawn at the position P₂, so that a picture of a (t+1)-th image frame can be obtained.

It should be noted that only one particle is illustrated as an example in the embodiment of the present disclosure, and the other particles are similar thereto, and will not be described in detail herein again.

Further, every time an image frame is obtained, a picture of the image frame is displayed on the screen of the computer system, and a picture composed of image frames corresponding to respective moments in a preset time period is a particle effect rendering result of the object to be rendered.

It should be understood that over time, because the vector value corresponding to the position of the surface of the object to be rendered in the force field is 0, all the particles will get closer and closer to the position where the surface of the object to be rendered is located, and eventually the shape of the object to be rendered is formed by the respective particles. That is, the particle effect rendering result is a process in which particles dynamically constitutes the shape of the object to be rendered.

In the embodiments of the present disclosure, the rendering of the particle effect is achieved by force field implementation, dynamic rendering of particles is achieved, thus obtaining a more spectacular rendering effect; and the force field of the object to be rendered is represented by a 3D texture map, so that the position of the particle in the force field with respect to the object to be rendered can be quickly obtained, thereby greatly improving the particle rendering efficiency.

In addition, particle motion is simulated by using a shader to compute on a GPU, the process supports a larger number of particles and a more spectacular force field effect can be achieved, thereby further improving the rendering effect of the particles.

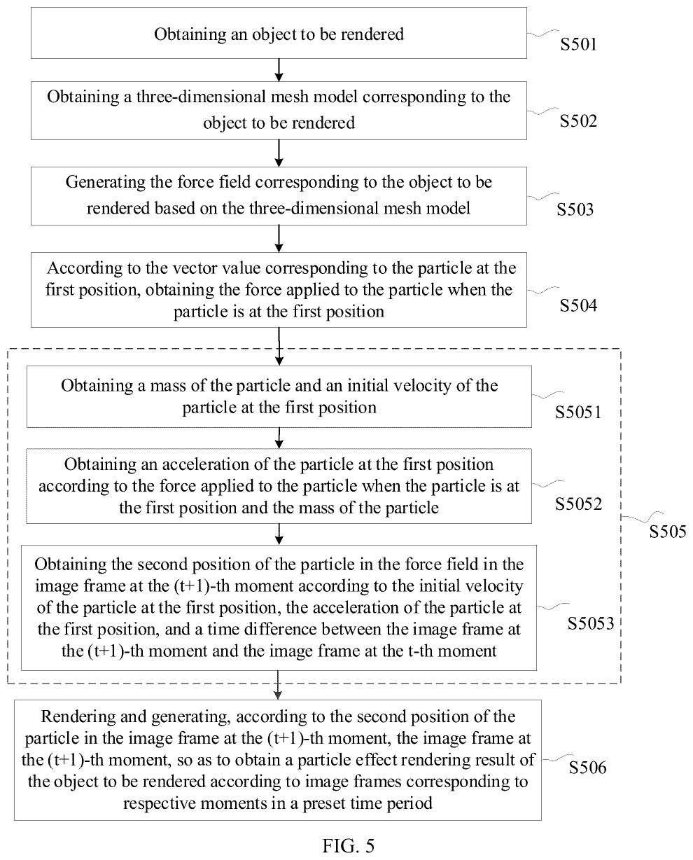

FIG. 5 is a second schematic flowchart diagram of a particle effect rendering method according to an embodiment of the present disclosure. Referring to FIG. 5, the particle effect rendering method provided by an embodiment of the present disclosure may include the following steps:
S501, obtaining an object to be rendered.
S502, obtaining a three-dimensional mesh model corresponding to the object to be rendered.
S503, generating the force field corresponding to the object to be rendered based on the three-dimensional mesh model.
S504, according to the vector value corresponding to the first position of the particle in the force field in the image frame at the t-th moment, obtaining the force applied to the particle when the particle is at the first position.

It should be noted that the force field can be a vector field or a signed distance field.

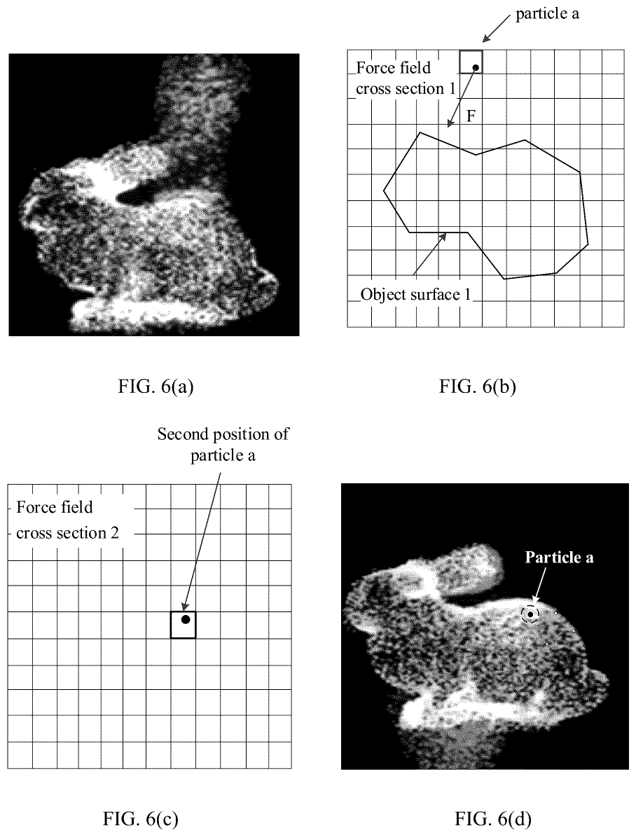

FIG. 6(a) to FIG. 6(d) are second schematic diagrams of a principle of a particle effect rendering method according to an embodiment of the present disclosure. The force field in FIGS. 6(a)-6(d) can be any one of the vector field and the signed distance field, and the embodiments of the present disclosure are not particularly limited thereto.

FIG. 6(a) is a rendering result of respective particles in the image frame at the t-th moment, and for any particle a in the image frame, the first position of the particle a in the force field can be obtained according to the 3D texture map of the force field.

Further, the magnitude of the force applied to the particle a when the particle a is located at the first position can be obtained according to the vector value corresponding to the first position.

In some embodiments, when the force field is a vector field, the force applied to the particle when the particle is at the first position in the vector field is the vector value corresponding to the first position.

In other embodiments, when the force field is a signed distance field, the signed distance field further comprises a shortest distance between the position and a surface of the object, and then step S504 specifically includes:
(1) determining a shortest distance between the first position and the surface of the object to be rendered.

FIG. 6(b) is a schematic cross-sectional view of a force field when a particle is in a first position. As shown in FIG. 6(b), the force field cross section 1 comprises a plurality of pixels (each grid in FIG. 6(b) represents one pixel), the shortest distances corresponding to respective pixels are different. An object surface 1 is a cross section of the object to be rendered in the force field cross section, the shortest distance to which each pixel corresponds is the shortest distance from the pixel to the object surface 1.
(2) determining a force applied to the particle when the particle is at the first position according to the vector value and the shortest distance corresponding to the particle at the first position.

In particular, the magnitude of the force F applied to the particle a when the particle a is at the first position is the product of the vector value and the shortest distance corresponding to the first position, and the direction of the force F applied to the particle a when the particle a is at the first position is towards the object surface 1.
S505, obtaining the second position of the particle in the force field in the image frame at the (t+1)-th moment according to the force applied to the particle when the particle is at the first position.

In an embodiment of the present disclosure, step S505 may include steps S5051 to S5053 as follows:
S5051, obtaining a mass of the particle and an initial velocity of the particle at the first position.

The mass of the particle is set when the particle system is generated, and the initial velocity at the first position is related to the time after the particle enters the force field. For example, if the t-th moment is the first moment after the particle enters the force field, the initial velocity of the particle at the first position is the initial velocity set for the particle when the particle system is generated, and if the t-th moment is not the first moment, the initial velocity of the particle at the first position is calculated based on the velocity of the particle at the (t−1)-th moment and the magnitude of the force applied to the particle at the (t−1)-th moment.

Specifically, the initial velocity Vₜ of the particle at the first position can be derived by the following formula:

$${V}_{t} = {V}_{t - 1} + \frac{{F}_{t - 1}}{m} \times {T}_{t}$$

Where Vₜ₋₁ is the velocity of the particle at the (t−1)-th moment, Fₜ₋₁ is the force applied to the particle at the (t−1)-th moment, m is the mass of the particle, and Tₜ is the time difference between the t-th moment and the (t−1)-th moment.

Specifically, taking as an example that 30 image frames are shown every one second in the particle rendering result, the time difference Tₜ between the t-th moment and the (t−1)-th moment is (1/30) seconds.
S5052, obtaining an acceleration of the particle at the first position according to the force applied to the particle when the particle is at the first position and the mass of the particle.

In particular, the acceleration at of the particle at the first position can be derived according to the following formula:

$${a}_{t} = \frac{{F}_{t}}{m}$$

Where Fₜ is the force applied to the particle when the particle is at the first position, m is the mass of the particle, and the direction of the acceleration coincides with the direction of Fₜ.

In an embodiment of the present disclosure, when the particle a is at the first position, the particle a is affected by Fₜ, thus generating an acceleration αₜ towards the object surface 1 and moving towards the object surface 1 according to the acceleration.
S5053, obtaining the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

Specifically, the displacement Sₜ₊₁ of the particle from the t-th moment to the (t+1)-th moment can be obtained by the following formula:

$${S}_{t + 1} = {V}_{t} \times {T}_{t + 1} + \frac{1}{2} {a}_{t}^{2}$$

Where Tₜ₊₁ is the time difference between the t-th moment and the (t+1)-th moment.

Further, the second position of the particle a in the force field in the image frame at (t+1)-th moment can be derived according to the displacement Sₜ₊₁ and the first position of the particle a, as shown in FIG. 6(c).

It should be noted that the method to obtain the second position of the other particles in the particle system is similar to that of the particle a, and will not be described in detail here again.
S506, rendering and generating, according to the second position of the particle in the image frame at the (t+1)-th moment, the image frame at the (t+1)-th moment, so as to obtain a particle effect rendering result of the object to be rendered according to respective image frames.

Further, according to the second positions of all the particles in the particle system, the respective particles are drawn, so that the rendering result of the respective particles in the image frame at the (t+1)-th moment as shown in FIG. 6(d) is obtained.

It should be understood that, after obtaining the image frame at the (t+1)-th moment, image frames at other moments can be obtained in the same manner, a video consisting of these image frames arranged in time sequence is the particle effect rendering result of the object to be rendered.

It should be understood that, over time, all the particles will get closer and closer to the position where the surface of the object to be rendered is located, and eventually the shape of the object to be rendered is formed by the respective particles. That is, the particle effect rendering result is a process in which particles dynamically constitutes the shape of the object to be rendered.

In the embodiments of the present disclosure, by obtaining the force field of the object to be rendered and performing the particle effect rendering on the object to be rendered according to the force field, dynamic rendering of particles can be achieved, thereby achieving a more spectacular rendering effect. In addition, by providing two rendering mode, namely the vector field and the signed distance field, the technical solution of the present disclosure can be flexibly applied to a variety of computing devices, thus improving development efficiency.

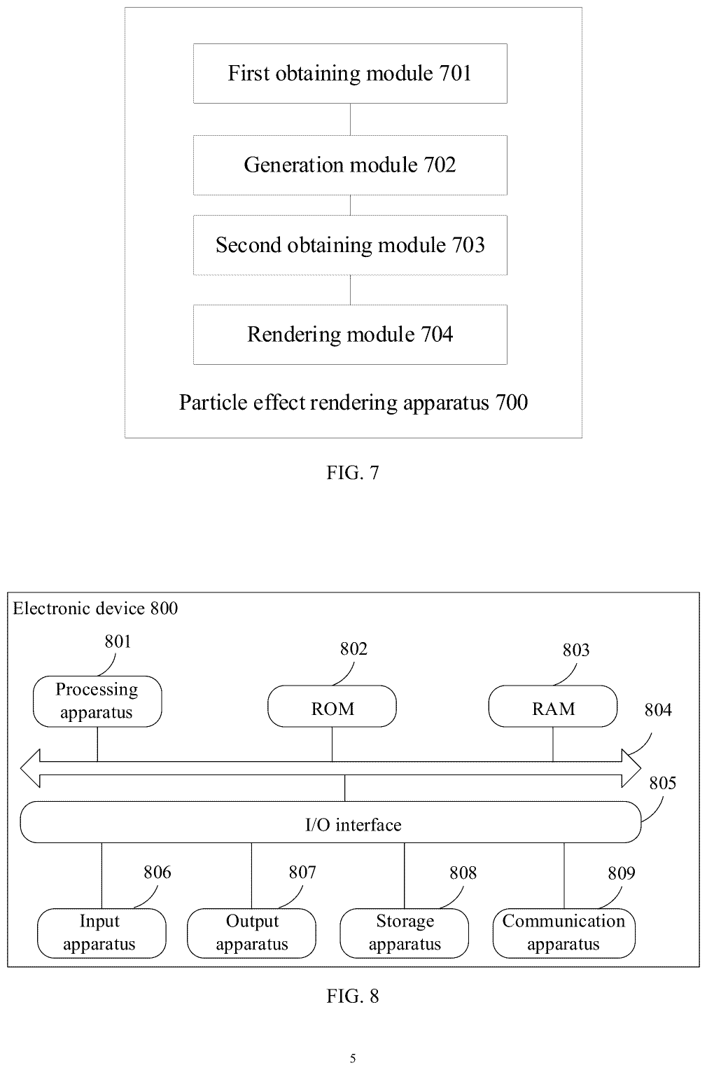

Corresponding to the particle effect rendering method shown in the above embodiment, FIG. 7 is a structural schematic diagram of a particle effect rendering apparatus according to an embodiment of the present disclosure. For ease of illustration, only parts relevant to embodiments of the present disclosure is described, as shown in FIG. 7, the particle effect rendering apparatus 700 includes:
a first obtaining module 701, configured to obtain an object to be rendered;
a generation module 702, configured to generate, based on the object to be rendered, a force field corresponding to the object to be rendered, the force field comprising one or more positions, and a vector value corresponding to the position being used to indicate a force applied to a particle when the particle is at the position;
a second obtaining module 703, configured to, based on a 3D texture map of the force field, obtain, according to a vector value corresponding to a first position of a particle in the force field in an image frame at a t-th moment, a second position of the particle in the force field in an image frame at a (t+1)-th moment, t being a non-negative integer; and a rendering module 704, configured to render and generate, according to the second position of the particle in the image frame at the (t+1)-th moment, the image frame at the (t+1)-th moment, so as to obtain a particle effect rendering result of the object to be rendered according to image frames corresponding to respective moments in a preset time period.

According to one or more embodiments of the present disclosure, the second obtaining module 703 is specifically configured to: obtain a force applied to the particle when the particle is at the first position according to the vector value corresponding to the particle at the first position; and obtain the second position of the particle in the force field in the image frame at the (t+1)-th moment according to the force applied to the particle when the particle is at the first position.

According to one or more embodiments of the present disclosure, the second obtaining module 703 is specifically configured to: obtain a mass of the particle and an initial velocity of the particle at the first position; obtain an acceleration of the particle at the first position according to the force applied to the particle when the particle is at the first position and the mass of the particle; and obtain the second position of the particle in the force field in the image frame at the (t+1)-th moment according to the initial velocity of the particle at the first position, the acceleration of the particle at the first position, and a time difference between the target image frame and the current image frame.

According to one or more embodiments of the present disclosure, the force field comprises a vector field.

According to one or more embodiments of the present disclosure, the force field comprises a signed distance field, and the signed distance field further comprises a shortest distance between each position and a surface of the object to be rendered; the second obtaining module 703 is further configured to: determine a shortest distance between the first position and the surface of the object to be rendered; and determine a force applied to the particle when the particle is at the first position according to the shortest distance and the vector value corresponding to the first position.

The above particle effect rendering apparatus provided by the embodiments of the present disclosure can be used to perform the technical solutions of the above particle effect rendering method, and its implementation principles and technical effects are similar to those of the above particle effect rendering method, which are not repeated here.

FIG. 8 is a structural schematic diagram of an electronic device according to an embodiment of the present disclosure. FIG. 8 shows a structural schematic diagram of an electronic device 800 suitable for implementing the embodiments of the present disclosure, the electronic device 800 can be the above-described terminal device or server. The terminal device can include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The server can be a stand-alone server, or can be a service cluster, or the like, which is not limited in the embodiments of the present disclosure.

It should be understood that the electronic device illustrated in FIG. 8 is merely an example, and should not pose any limitation to the functions and the range of use of the embodiments of the present disclosure.

As shown in FIG. 8, the electronic device 800 can include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected to each other by means of a bus 804. An input/output (I/O) interface 805 is also connected to the bus 804.

Usually, the following apparatus can be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or provided alternatively.

Particularly, according to the embodiments of the present disclosure, the processes described above with reference to the flowcharts can be implemented as a computer software program. For example, the embodiments of the present disclosure include a computer program product, which includes a computer program carried on a computer-readable medium. The computer program includes program codes for performing the methods shown in the flowcharts. In such embodiments, the computer program may be downloaded from the network through the communication apparatus 809 and installed, or may be installed from the storage apparatus 808, or may be installed from the ROM 802. When the computer program is executed by the processing apparatus 801, the above-mentioned functions defined in the method of the embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semi-conductive system, apparatus, or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disc read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device.

In the present disclosure, the computer-readable signal medium may include a data signal that propagates in a baseband or as a part of a carrier wave and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, when the one or more programs are executed by the electronic device, the electronic device is caused to perform the particle effect rendering method shown in the above-described embodiments.

In some embodiments, the computer program codes for performing the operations of the present disclosure can be written in one or more programming languages or a combination thereof. The above-mentioned programming languages include object-oriented programming languages such as Java, Smalltalk, C++, and also include conventional procedural programming languages such as the “C” programming language or similar programming languages. The program code can be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate system architectures, functions, and operations that may be implemented by the system, method, and computer program products according to the various embodiments of the present disclosure. In this regard, each block in the flowcharts or block diagrams may represent a module, a program segment, or a part of code, and the module, the program segment, or the part of code includes one or more executable instructions for implementing specified logic functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the block diagrams and/or flowcharts and combinations of the blocks in the block diagrams and/or flowcharts may be implemented by a dedicated hardware-based system for executing specified functions or operations, or may be implemented by a combination of a dedicated hardware and computer instructions.

The units involved in the embodiments described in the present disclosure may be implemented by software, or may be implemented by hardware. The name of a unit does not constitute a limitation on the unit itself. For example, the first obtaining unit may also be described as “a unit that obtains at least two Internet protocol addresses”.

The functions described above in the present disclosure may be executed at least in part by one or more hardware logic components. For example, without limitations, exemplary types of the hardware logic components that can be used include: a field-programmable gate array (FPGA), an application specific integrated circuit (ASIC), an application specific standard product (ASSP), a system on chip (SOC), a complex programmable logic device (CPLD), and the like.

In the context of the present disclosure, a machine readable medium may be a tangible medium that may contain or store a program for use by or in combination with an instruction execution system, apparatus, or device. The machine readable medium may be a machine readable signal medium or a machine readable storage medium. The machine readable medium may include but not be limited to an electronic, magnetic, optical, electromagnetic, infrared, or semi-conductive system, apparatus, or device, or any appropriate combination of them. More specific examples of the machine readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of them.

In a first aspect, according to one or more embodiments of the present disclosure, a particle effect rendering method is provided and comprises:
obtaining an object to be rendered; generating, based on the object to be rendered, a force field corresponding to the object to be rendered, a vector value corresponding to each position in the force field being used to indicate a force applied to a particle at the position; based on a 3D texture map of the force field, obtaining, according to a vector value corresponding to a first position of a particle in the force field in an image frame at a t-th moment, a second position of the particle in the force field in an image frame at a (t+1)-th moment, t being a non-negative integer; and rendering and generating, according to the second position of the particle in the image frame at the (t+1)-th moment, the image frame at the (t+1)-th moment, so as to obtain a particle effect rendering result of the object to be rendered according to image frames corresponding to respective moments in a preset time period.

According to one or more embodiments of the present disclosure, the obtaining, according to a vector value corresponding to a first position of a particle in the force field in an image frame at a t-th moment, a second position of the particle in the force field in an image frame at a (t+1)-th moment comprises: obtaining a force applied to the particle when the particle is at the first position according to the vector value corresponding to the particle at the first position; and obtaining the second position of the particle in the force field in the image frame at the (t+1)-th moment according to the force applied to the particle when the particle is at the first position.

According to one or more embodiments of the present disclosure, the obtaining the second position of the particle in the force field in the image frame at the (t+1)-th moment according to the force applied to the particle when the particle is at the first position comprises: obtaining a mass of the particle and an initial velocity of the particle at the first position; obtaining an acceleration of the particle at the first position according to the force applied to the particle when the particle is at the first position and the mass of the particle; and obtaining the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

According to one or more embodiments of the present disclosure, the force field comprises a vector field.

According to one or more embodiments of the present disclosure, the force field comprises a signed distance field, and the signed distance field further comprises a shortest distance between each of the positions and a surface of the object to be rendered.

The particle effect rendering method further comprises: determining a shortest distance between the first position and the surface of the object to be rendered; and determining a force applied to the particle when the particle is at the first position according to the shortest distance and the vector value corresponding to the first position.

According to one or more embodiments of the present disclosure, the generating, based on the object to be rendered, a force field corresponding to the object to be rendered comprises: obtaining a three-dimensional mesh model corresponding to the object to be rendered; and generating the force field corresponding to the object to be rendered based on the three-dimensional mesh model.

In a second aspect, according to one or more embodiments of the present disclosure, a particle effect rendering apparatus is provided and comprises: a first obtaining module, configured to obtain an object to be rendered; a generation module, configured to generate, based on the object to be rendered, a force field corresponding to the object to be rendered, the force field comprising one or more positions, and a vector value corresponding to the position being used to indicate a force applied to a particle when the particle is at the position; a second obtaining module, configured to, based on a 3D texture map of the force field, obtain, according to a vector value corresponding to a first position of a particle in the force field in an image frame at a t-th moment, a second position of the particle in the force field in an image frame at a (t+1)-th moment, t being a non-negative integer; and a rendering module, configured to render and generate, according to the second position of the particle in the image frame at the (t+1)-th moment, the image frame at the (t+1)-th moment, so as to obtain a particle effect rendering result of the object to be rendered according to image frames corresponding to respective moments in a preset time period.

According to one or more embodiments of the present disclosure, the second obtaining module 703 is specifically configured to: obtain a force applied to the particle when the particle is at the first position according to the vector value corresponding to the particle at the first position; and obtain the second position of the particle in the force field in the image frame at the (t+1)-th moment according to the force applied to the particle when the particle is at the first position.

According to one or more embodiments of the present disclosure, the second obtaining module 703 is specifically configured to: obtain a mass of the particle and an initial velocity of the particle at the first position; obtain an acceleration of the particle at the first position according to the force applied to the particle when the particle is at the first position and the mass of the particle; and obtain the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

According to one or more embodiments of the present disclosure, the force field comprises a vector field.

According to one or more embodiments of the present disclosure, the force field comprises a signed distance field, and the signed distance field further comprises a shortest distance between each position and a surface of the object to be rendered; the second obtaining module 703 is further configured to: determine a shortest distance between the first position and the surface of the object to be rendered; and determine a force applied to the particle when the particle is at the first position according to the shortest distance and the vector value corresponding to the first position.

In a third aspect, according to one or more embodiments of the present disclosure, an electronic device is provided and comprises: at least one processor and a memory; the memory stores computer-executable instructions; when the at least one processor executes the computer-executable instructions stored in the memory, the at least one processor is caused to perform the particle effect rendering method as described in the first aspect.

In a fourth aspect, according to one or more embodiments of the present disclosure, a computer-readable storage medium is provided, the computer-readable storage medium stores computer-executable instructions, when a processor executes the computer-executable instructions, the particle effect rendering method as described in the first aspect is implemented.

In a fifth aspect, according to one or more embodiments of the present disclosure, a program product is provided and comprises: a computer program, and the computer program, when executed by a processor, implements the particle effect rendering method as described in the first aspect.

In a sixth aspect, according to one or more embodiments of the present disclosure, a computer program is provided, and the computer program, when executed by a processor, implements the particle effect rendering method as described in the first aspect.

The foregoing descriptions are merely the illustrations of the preferred embodiments of the present disclosure and the explanations of the applied technical principles. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, although operations have been described in a particular order, it shall not be construed as requiring that such operations are performed in the stated particular order or in a sequential order. Under certain circumstances, multitasking and parallel processing may be advantageous. Similarly, although some specific implementation details are included in the above discussions, these shall not be construed as limitations to the scope of the present disclosure. Some features described in the context of a separate embodiment may also be implemented in combination in a single embodiment. Conversely, various features described in the context of a single embodiment may also be implemented in various embodiments individually or in a plurality of embodiments in any appropriate sub-combination.

Although the present subject matter has been described in a language specific to structural features and/or logical method acts, it will be appreciated that the subject matter defined in the appended claims is not necessarily limited to the particular features or acts described above. Rather, the particular features and acts described above are merely exemplary forms for implementing the claims.

1. A particle effect rendering method, comprising:
obtaining an object to be rendered;
generating, based on the object to be rendered, a force field corresponding to the object to be rendered, wherein the force field comprises one or more positions, and a vector value corresponding to a position of the one or more positions is used to indicate a force applied to a particle when the particle is at the position;
based on a 3D texture map of the force field, obtaining, according to a vector value corresponding to a first position of a particle in the force field in an image frame at a t-th moment, a second position of the particle in the force field in an image frame at a (t+1)-th moment, wherein t is a non-negative integer; and
rendering and generating, according to the second position of the particle in the force field in the image frame at the (t+1)-th moment, the image frame at the (t+1)-th moment, so as to obtain a particle effect rendering result of the object to be rendered according to image frames corresponding to respective moments in a preset time period.

2. The particle effect rendering method according to claim 1, wherein the obtaining, according to a vector value corresponding to a first position of a particle in the force field in an image frame at a t-th moment, a second position of the particle in the force field in an image frame at a (t+1)-th moment comprises:
obtaining a force applied to the particle when the particle is at the first position according to the vector value corresponding to the first position of the particle; and
obtaining the second position of the particle in the force field in the image frame at the (t+1)-th moment according to the force applied to the particle when the particle is at the first position.

3. The particle effect rendering method according to claim 2, wherein the obtaining the second position of the particle in the force field in the image frame at the (t+1)-th moment according to the force applied to the particle when the particle is at the first position comprises:
obtaining a mass of the particle and an initial velocity of the particle at the first position;
obtaining an acceleration of the particle at the first position according to the force applied to the particle when the particle is at the first position and the mass of the particle; and
obtaining the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

4. The particle effect rendering method according to claim 1, wherein the force field comprises a vector field.

5. The particle effect rendering method according to the claim 1, wherein the force field comprises a signed distance field, and the signed distance field further comprises a shortest distance between each of the one or more positions and a surface of the object to be rendered; the particle effect rendering method further comprises:
determining a shortest distance between the first position and the surface of the object to be rendered; and
determining a force applied to the particle when the particle is at the first position according to the shortest distance and the vector value corresponding to the first position.

6. The particle effect rendering method according to claim 1, wherein the generating, based on the object to be rendered, a force field corresponding to the object to be rendered comprises:
obtaining a three-dimensional mesh model corresponding to the object to be rendered; and
generating the force field corresponding to the object to be rendered based on the three-dimensional mesh model.

7. (canceled)

8. An electronic device, comprising: at least one processor and a memory;
wherein the memory stores computer-executable instructions; and
when the at least one processor executes the computer-executable instructions stored in the memory, the at least one processor is caused to perform a particle effect rendering method,
wherein the particle effect rendering method comprises:
obtaining an object to be rendered;
generating, based on the object to be rendered, a force field corresponding to the object to be rendered, wherein the force field comprises one or more positions, and a vector value corresponding to a position of the one or more positions is used to indicate a force applied to a particle when the particle is at the position;
based on a 3D texture map of the force field, obtaining, according to a vector value corresponding to a first position of a particle in the force field in an image frame at a t-th moment, a second position of the particle in the force field in an image frame at a (t+1)-th moment, wherein t is a non-negative integer; and
rendering and generating, according to the second position of the particle in the force field in the image frame at the (t+1)-th moment, the image frame at the (t+1)-th moment, so as to obtain a particle effect rendering result of the object to be rendered according to image frames corresponding to respective moments in a preset time period.

9. A non-transitory computer-readable storage medium, wherein the non-transitory computer-readable storage medium stores computer-executable instructions, when a processor executes the computer-executable instructions, a particle effect rendering method is implemented,
wherein the particle effect rendering method comprises:
obtaining an object to be rendered;
generating, based on the object to be rendered, a force field corresponding to the object to be rendered, wherein the force field comprises one or more positions, and a vector value corresponding to a position of the one or more positions is used to indicate a force applied to a particle when the particle is at the position;
based on a 3D texture map of the force field, obtaining, according to a vector value corresponding to a first position of a particle in the force field in an image frame at a t-th moment, a second position of the particle in the force field in an image frame at a (t+1)-th moment, wherein t is a non-negative integer; and
rendering and generating, according to the second position of the particle in the force field in the image frame at the (t+1)-th moment, the image frame at the (t+1)-th moment, so as to obtain a particle effect rendering result of the object to be rendered according to image frames corresponding to respective moments in a preset time period.

10-11. (canceled)

12. The particle effect rendering method according to claim 2, wherein the force field comprises a vector field.

13. The particle effect rendering method according to claim 3, wherein the force field comprises a vector field.

14. The particle effect rendering method according to claim 2, wherein the force field comprises a signed distance field, and the signed distance field comprises a shortest distance between each of the one or more positions and a surface of the object to be rendered; the particle effect rendering method further comprises:
determining a shortest distance between the first position and the surface of the object to be rendered; and
determining a force applied to the particle when the particle is at the first position according to the shortest distance and the vector value corresponding to the first position.

15. The particle effect rendering method according to claim 3, wherein the force field comprises a signed distance field, and the signed distance field comprises a shortest distance between each of the one or more positions and a surface of the object to be rendered; the particle effect rendering method further comprises:
determining a shortest distance between the first position and the surface of the object to be rendered; and
determining a force applied to the particle when the particle is at the first position according to the shortest distance and the vector value corresponding to the first position.

16. The particle effect rendering method according to claim 2, wherein the generating, based on the object to be rendered, a force field corresponding to the object to be rendered comprises:
obtaining a three-dimensional mesh model corresponding to the object to be rendered; and
generating the force field corresponding to the object to be rendered based on the three-dimensional mesh model.

17. The particle effect rendering method according to claim 3, wherein the generating, based on the object to be rendered, a force field corresponding to the object to be rendered comprises:
obtaining a three-dimensional mesh model corresponding to the object to be rendered; and
generating the force field corresponding to the object to be rendered based on the three-dimensional mesh model.

18. The particle effect rendering method according to claim 5, wherein the generating, based on the object to be rendered, a force field corresponding to the object to be rendered comprises:
obtaining a three-dimensional mesh model corresponding to the object to be rendered; and
generating the force field corresponding to the object to be rendered based on the three-dimensional mesh model.

19. The electronic device according to claim 8, wherein the obtaining, according to a vector value corresponding to a first position of a particle in the force field in an image frame at a t-th moment, a second position of the particle in the force field in an image frame at a (t+1)-th moment comprises:
obtaining a force applied to the particle when the particle is at the first position according to the vector value corresponding to the first position of the particle; and
obtaining the second position of the particle in the force field in the image frame at the (t+1)-th moment according to the force applied to the particle when the particle is at the first position.

20. The electronic device according to claim 19, wherein the obtaining the second position of the particle in the force field in the image frame at the (t+1)-th moment according to the force applied to the particle when the particle is at the first position comprises:
obtaining a mass of the particle and an initial velocity of the particle at the first position;
obtaining an acceleration of the particle at the first position according to the force applied to the particle when the particle is at the first position and the mass of the particle; and
obtaining the second position of the particle in the force field in the image frame at the (t+1)-th moment according to the initial velocity of the particle at the first position, the acceleration of the particle at the first position, and a time difference between the image frame at the (t+1)-th moment and the image frame at the t-th moment.

21. The electronic device according to claim 8, wherein the force field comprises a vector field.

22. The electronic device according to claim 8, wherein the force field comprises a signed distance field, and the signed distance field comprises a shortest distance between each of the one or more positions and a surface of the object to be rendered; the particle effect rendering method further comprises:
determining a shortest distance between the first position and the surface of the object to be rendered; and
determining a force applied to the particle when the particle is at the first position according to the shortest distance and the vector value corresponding to the first position.

23. The electronic device according to claim 8, wherein the generating, based on the object to be rendered, a force field corresponding to the object to be rendered comprises:
obtaining a three-dimensional mesh model corresponding to the object to be rendered; and
generating the force field corresponding to the object to be rendered based on the three-dimensional mesh model.
